(19) United States
(12) Patent Application Publication
(10) Pub. No.: US 2024/0370739 A1
(43) Pub. Date: Nov. 7, 2024

(54) TRAINED MODEL VERIFICATION SYSTEM

(71) Applicant: Mitsubishi Electric Corporation, Tokyo (JP)

(72) Inventors: Saori Matsunaga, Tokyo (JP); Genta YOSHIMURA, Tokyo (JP); Yoshihiro MITSUKA, Tokyo (JP)

(73) Assignee: Mitsubishi Electric Corporation, Tokyo (JP)

(21) Appl. No.: 18/774,166

(22) Filed: Jul. 16, 2024

Related U.S. Application Data
(63) Continuation of application No. PCT/JP2022/007063, filed on Feb. 22, 2022.

(51) Int. Cl. G06N 5/01; G06F 18/10; G06F 18/21; G06N 3/09

(52) U.S. Cl. CPC G06N 5/01; G06F 18/10; G06F 18/217; G06N 3/09

(57) ABSTRACT

A trained model verification system according to the present disclosed technique includes: a rule model convertor that converts a trained model to be verified into a rule model having an input/output relationship equivalent to that of the trained model; a verification data set generator that generates a verification data set for the rule model; and a verificator that verifies the rule model or the trained model using the verification data set.

### CROSS REFERENCE TO RELATED APPLICATIONS

This application is a Continuation of PCT International Application No. PCT/JP2022/007063, filed on Feb. 22, 2022, which is hereby expressly incorporated by reference into the present application.

### TECHNICAL FIELD

The present disclosed technique relates to a trained model verification system.

### BACKGROUND ART

In the field of machine learning, a technique for comprehensively evaluating validity of a trained model is known.

For example, Patent Literature 1 discloses a configuration including an arithmetic device that, in a case where a trained model is a decision tree, obtains a decision tree logical expression by logically combining path logical expressions indicating decision tree paths in the decision tree, creates a combined logical expression by logically combining a verification property logical expression and an objective variable calculation logical expression with the decision tree logical expression, performs satisfiability determination by inputting the combined logical expression to a satisfiability determiner, and acquires a violation input value that is a value of an explanatory variable violating a verification property and a violation output value that is a value of an objective variable from a corresponding satisfaction solution in a case where satisfaction is indicated from a result of the determination.

### CITATION LIST

### Patent Literature

Patent Literature 1: JP 2020-135171 A

### SUMMARY OF INVENTION

### Technical Problem

In the verification technique disclosed in Patent Literature 1, an object to be verified is a machine learning program that operates according to an algorithm including a decision tree.

However, there is a need to verify a program or a mathematical model based on an algorithm other than an algorithm including a decision tree with a framework of the decision tree.

An object of the present disclosed technique is to solve the above problem and to provide a trained model verification system that enables verification of a mathematical model based on an algorithm other than an algorithm including a decision tree with a framework of the decision tree.

### Solution to Problem

A trained model verification system according to the present disclosed technique includes: a rule model convertor that converts a trained model to be verified into a rule model having an input/output relationship equivalent to that of the trained model; a verification data set generator that generates a verification data set for the rule model; and a verificator that verifies the rule model or the trained model using the verification data set.

### Advantageous Effects of Invention

The trained model verification system according to the present disclosed technique has the above configuration, and therefore enables verification of a mathematical model based on an algorithm other than an algorithm including a decision tree with a framework of the decision tree.

### BRIEF DESCRIPTION OF DRAWINGS

FIG. 1 is a block diagram illustrating a functional configuration of a trained model verification system according to a first embodiment.

FIG. 2 is an explanatory diagram illustrating an example of a verification condition TC according to the present disclosed technique.

FIG. 3 is an explanatory diagram No. 1 illustrating a feature amount space according to the present disclosed technique.

FIG. 4 is an explanatory diagram No. 2 illustrating the feature amount space according to the present disclosed technique.

FIG. 5 is an explanatory diagram No. 3 illustrating the feature amount space according to the present disclosed technique.

FIG. 6 is a diagram illustrating evaluation indexes according to the present disclosed technique as a table.

FIG. 7 is a diagram illustrating evaluation indexes according to the present disclosed technique in a form of a tree.

FIG. 8 is a diagram illustrating evaluation indexes according to the present disclosed technique in a form of a graph.

FIG. 9 is a flowchart illustrating processing steps of the trained model verification system according to the first embodiment.

FIGS. 10A and 10B are diagrams illustrating hardware configuration of a trained model verification system according to the present disclosed technique. FIG. 10A is a diagram in a case where functions of the trained model verification system are executed by hardware. FIG. 10B is a diagram in a case where functions of the trained model verification system are executed by software.

### DESCRIPTION OF EMBODIMENTS

A trained model verification system according to the present disclosed technique verifies a trained artificial intelligence, that is, a trained mathematical model. In the present specification, a mathematical model to be verified by the trained model verification system according to the present disclosed technique will be referred to as a trained model AI. Training performed in the trained model AI is based on supervised training. In addition, a training problem to be solved by the trained model AI is regression, classification, or recognition. The recognition includes image recognition, voice recognition, and the like.

The present disclosed technique converts the trained model AI into a mathematical model of a decision tree, more specifically, into a rule model, and performs verification with a framework of the decision tree.

The term “rule model” used in the present specification means a mathematical model expressed by an If-Then rule. The rule model includes, for example, a single decision tree and a decision list.

Even when the trained model AI is, for example, a convolutional neural network (CNN) that performs image recognition, verification with a framework of a decision tree is possible if a source code is known. When the trained model AI is a CNN, a relationship between an output value output in a final fully connected layer and a result of image recognition can be described by the If-Then rule. In addition, when the trained model AI is a CNN, there is a feature amount map as an intermediate product, and a relationship between a position in the feature amount map and a result of image recognition can also be described by the If-Then rule.

In the present specification, a name used as a common noun is not denoted by a reference sign, a name used as a proper noun indicating a specific thing is denoted by a reference sign, and these are distinguished from each other. For example, when a trained model is used as a common noun, “trained model” is simply used, and when the trained model is used as a proper noun, “trained model AI” is used. When a training data sample is used as a common noun, “training data sample” is simply used, and when the training data sample is used as a proper noun, “training data sample DS” is used. When a verification condition is used as a common noun, “verification condition” is simply used, and when the verification condition is used as a proper noun, “verification condition TC” is used. Hereinafter, similar rules apply to other terms.

As described above, the trained model AI is a trained model to be verified by a verification device 100 in the present disclosed technique. The reference sign AI is derived from initial letters of Artificial Intelligence. The trained model AI may be either a single model or a combination of a plurality of models based on ensemble training. The trained model AI may be, for example, a rule model if the trained model AI is a single model. The trained model AI may use a training algorithm such as random forest or boosting represented by gradient boosting if the trained model AI is based on ensemble training.

A training data sample DS is a sample of a data set used in a training phase of the trained model AI. The reference sign DS is derived from initial letters of Data Sample.

A verification condition TC is a condition determined for each model, and is a condition to be satisfied by a set of an input value and an output value of the model. The reference sign TC is derived from initial letters of Test Condition. It can be said that the model is a set of rules on what output value is output to an input value to the model.

In the present specification, an expression “This set violates the verification condition TC” is used for a set of an input value and an output value that do not satisfy the verification condition TC. Even when a certain rule regarding an input value and an output value does not satisfy the verification condition TC, an expression “This rule violates the verification condition TC” is used.

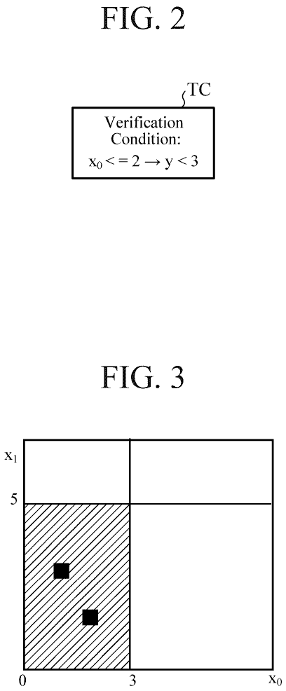

FIG. 2 is an explanatory diagram illustrating an example of the verification condition TC. In FIG. 2, x₀ represents an input value. In FIG. 2, y represents an output value. As illustrated in FIG. 2, the verification condition TC indicates a condition to be satisfied by a set of an input value and an output value.

### First Embodiment

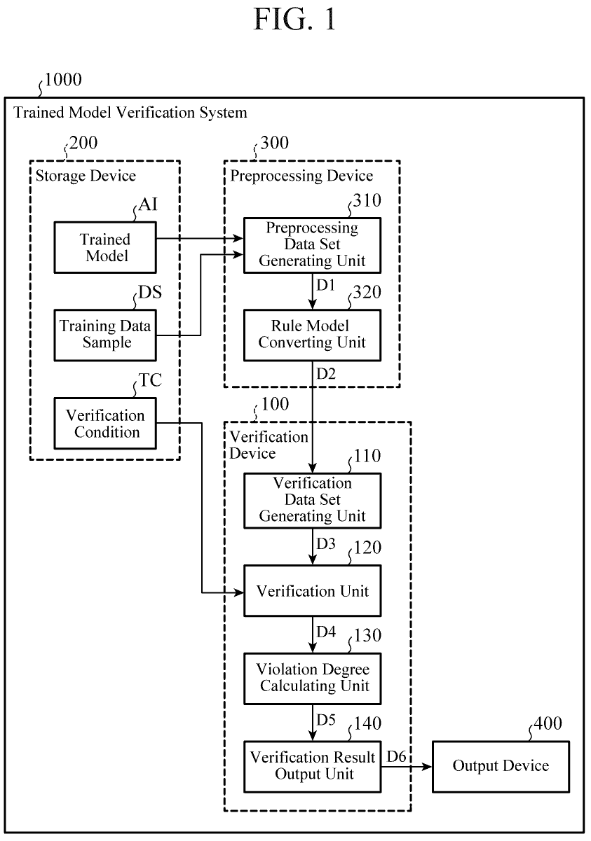

FIG. 1 is a block diagram illustrating a functional configuration of a trained model verification system 1000 according to a first embodiment. As illustrated in FIG. 1, the trained model verification system 1000 according to the first embodiment includes a storage device 200, a preprocessing device 300, an output device 400, and a verification device 100.

As illustrated in FIG. 1, the preprocessing device 300 of the trained model verification system 1000 according to the first embodiment includes a preprocessing data set generating unit 310 and a rule model converting unit 320.

As illustrated in FIG. 1, the verification device 100 of the trained model verification system 1000 according to the first embodiment includes a verification data set generating unit 110, a verification unit 120, a violation degree calculating unit 130, and a verification result output unit 140.

In the trained model verification system 1000 according to the first embodiment, functional blocks are connected to each other as illustrated in FIG. 1.

### <<Verification Device 100>>

The verification device 100 is a component for verifying the trained model AI converted into a rule model (hereinafter, referred to as a “trained rule model”). The verification device 100 performs calculation necessary for verifying the trained rule model. A result verified by the verification device 100 is output via the output device 400.

### <<Storage Device 200>>

The storage device 200 is a component for storing the trained model AI to be verified, the training data sample DS, and the verification condition TC.

The storage device 200 may be one or more network storage devices disposed on a communication network. In this case, the trained model verification system 1000 accesses the storage device 200 via the network.

### <<Preprocessing Device 300>>

The preprocessing device 300 is a component for performing preprocessing on the trained model AI to be verified.

Specifically, the preprocessing device 300 converts the trained model AI into a rule model. That is, the term “preprocessing” used here specifically means conversion into a rule model.

When the trained model AI is already a rule model, processing of the preprocessing device 300 is omitted.

### <<Output Device 400>>

The output device 400 is a component for outputting an output result of the verification device 100 to the outside.

### <<Operation of Trained Model Verification System 1000 According to First Embodiment>>

As illustrated in FIG. 1, the trained model AI stored in the storage device 200 is sent to the preprocessing data set generating unit 310 of the preprocessing device 300.

The preprocessing data set generating unit 310 is a component for generating a preprocessing data set D1 when the trained model AI is converted into a rule model. The preprocessing data set D1 is a data set for preprocessing. The data set is a set including input data and output data including an output corresponding to each of pieces of the input data.

The input data of the preprocessing data set D1 is created in consideration of a boundary value of a branch condition of the trained model AI.

The preprocessing data set D1 generated by the preprocessing data set generating unit 310 is sent to the rule model converting unit 320.

FIG. 3 is an explanatory diagram No. 1 illustrating a feature amount space according to the present disclosed technique. A horizontal axis of the feature amount space illustrated in FIG. 3 indicates a first input x₀, and a vertical axis thereof indicates a second input x₁. That is, for the sake of simplicity, an input is equal to a feature amount in FIG. 3. Here, FIG. 3 represents the feature amount space when the trained model AI performs classification, that is, predicts a category. In the feature amount space illustrated in FIG. 3, a hatched region (0≤x₀≤3 and 0≤x₁≤5) indicates a certain category (Category is also referred to as class.) to which the input data belongs. In consideration with a framework of a decision tree, it can be expressed that the hatched region in FIG. 3 indicates a certain leaf in the decision tree. Note that a region in the feature amount space may be referred to as a “partial space in the feature amount space”.

Each of two black square plots in FIG. 3 indicates the training data samples DS of the trained model AI.

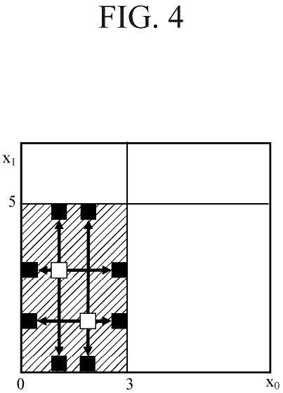

FIG. 4 is an explanatory diagram No. 2 illustrating the feature amount space according to the present disclosed technique. Also in the feature amount space illustrated in FIG. 4, similarly to FIG. 3, a hatched region (0≤x₀≤3 and 0≤x₁≤5) indicates a portion determined to be a region indicating a certain category as a result of training.

When the hatched region is trained as a region indicating a certain category as illustrated in FIG. 4, it can be predicted that there should be, in a training data set, a piece of data corresponding to a plot near a boundary in the hatched region.

However, although a boundary shape of a region indicating a certain category in the feature amount space is originally complicated, the boundary shape may be simplified by a linear support vector machine or the like.

FIG. 4 indicates that it is important to verify whether the trained model AI performs correct inference on an input corresponding to the vicinity of a boundary of a region indicating a category.

One of things to be confirmed using the feature amount space is correspondence between a boundary shape of a region indicating a certain category and a plot position of the training data sample DS belonging to the category.

What should be performed next using the feature amount space is to create, in a case where there is no plot of the training data sample DS near a boundary of a region indicating a certain category, a data set in which a feature amount is plotted near the boundary of the region by back calculation. In a case where the trained model AI is a neural network, this back calculation is preferably performed by applying back propagation.

A white square plot in FIG. 4 is synonymous with the black square plot in FIG. 3. A black square plot in FIG. 4 indicates that a plot near a boundary of a region is created with the plot (white square plot) of the existing training data sample DS as a base point. For example, in a case where the trained model AI is a CNN that performs image recognition, an image in which a feature amount is plotted near the boundary of the region and a correct answer label are generated by back calculation.

Whether the training data set generated by back calculation is meaningful as a training data set is preferably determined finally by observation of the training data set by a human. For example, in a case where the trained model AI is a CNN that performs image recognition, whether the image and the correct answer label generated by back calculation are meaningful is determined finally by observation of the image and the correct answer label by a human.

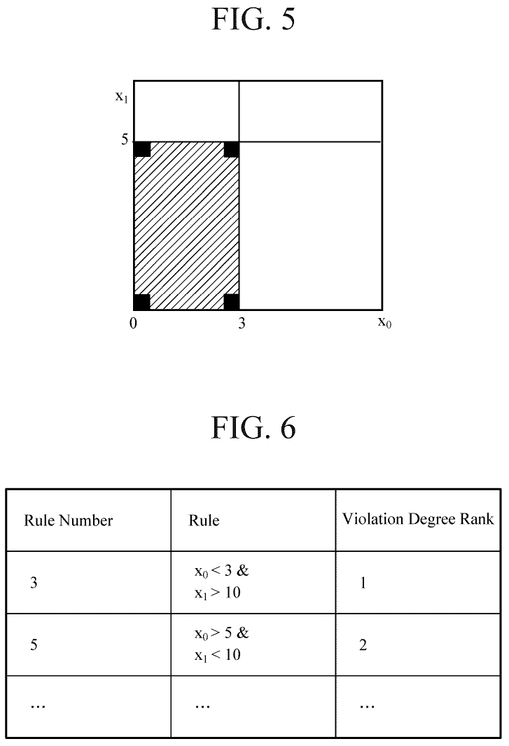

FIG. 5 is an explanatory diagram No. 3 illustrating the feature amount space according to the present disclosed technique.

In FIG. 4, a plot near a boundary of a region is created with a plot (white square plot) of the existing training data sample DS as a base point, but the present disclosed technique is not limited thereto. As illustrated in FIG. 5, in the present disclosed technique, a plot near the boundary of the region may be created regardless of a plot (white square plot) of the existing training data sample DS.

FIGS. 3 to 5 illustrate the feature amount space as a two-dimensional space in consideration of visibility, but the feature amount space is generally multidimensional (n-dimensional).

Generation of training data corresponding to the vicinity of the boundary of the region is preferably performed for all categories in a case where the trained model AI solves a classification problem.

A training data set generated by the preprocessing data set generating unit 310 and determined to be meaningful by observation of the training data set by a human is referred to as a preprocessing data set D1 in the present specification. The preprocessing data set D1 includes an explanatory variable x and an objective variable y_{ensemble}. The preprocessing data set D1 is sent to the rule model converting unit 320.

The rule model converting unit 320 is a component for generating a rule model D2 in consideration of information of the preprocessing data set D1 when the trained model AI is not a rule model (for example, when the trained model AI is an ensemble model of a decision tree).

The rule model converting unit 320 generates the rule model D2 that reproduces the trained model AI in a form of a rule model.

As described above, when the trained model AI is already a rule model, processing of the preprocessing device 300 is omitted. The rule model D2 generated by the preprocessing device 300 is sent to the verification data set generating unit 110 of the verification device 100.

In general, in a final stage of a training phase of artificial intelligence, work of preparing a verification data set different from a training data set and verifying whether training has been performed as intended is performed.

The verification data set generating unit 110 is a component for generating a verification data set for the rule model D2.

As in the training data set, also in the verification data set, it is important to check where a piece of data is plotted in the feature amount space. Also in the verification data set, it is important that there is a piece of data plotted near a boundary of each category.

In a case where there is no plot of verification data near a boundary of a region indicating a category, a data set in which a feature amount is plotted near the boundary of the region is preferably created by back calculation. The generation of the verification data set by back calculation is preferably performed by a similar method to the method for generating the training data set by back calculation.

Whether the verification data set generated by back calculation is meaningful as a verification data set is preferably determined by observation of the verification data set by a human.

A data set generated by the verification data set generating unit 110 and determined to be meaningful by observation of the data set by a human is referred to as a verification data set D3 in the present specification. The verification data set D3 includes an explanatory variable xₜₑₛₜ and an objective variable yₜₑₛₜ. The verification data set D3 is sent to the verification unit 120.

The preprocessing data set generating unit 310 and the verification data set generating unit 110 may each generate the minimum number of samples required for verification while covering a value range of input data. In addition, the preprocessing data set generating unit 310 and the verification data set generating unit 110 may each generate a data set by extracting a boundary value condition of each branch of a rule model.

The verification unit 120 is a component that verifies the rule model D2 or the trained model AI using the verification data set D3. More specifically, the verification unit 120 is a component for verifying whether the trained model AI has been trained as intended.

In the verification performed by the verification unit 120, an originally prepared verification data set and the verification data set D3 generated by the verification data set generating unit 110 are used.

In addition, in the verification performed by the verification unit 120, the verification condition TC in which a prediction range of a region of each category obtained by training of the trained model AI is expressed by a mathematical expression may be referred to.

The verification unit 120 outputs a verification result as D4 to the violation degree calculating unit 130.

It can be said that the violation degree calculating unit 130 is a component for calculating an evaluation index such as a correct answer ratio of the trained model AI. Specifically, the violation degree calculating unit 130 may calculate, for the trained model AI, evaluation indexes of an accuracy, a precision, a recall, a specificity, and an F-measure for each category.

In addition, the violation degree calculating unit 130 may calculate a violation degree as an evaluation index of the trained model AI. Here, the violation degree may be a value obtained by setting the number of verification data sets D3 in which a correct answer label belongs to a certain category as a denominator and setting the number of erroneous classifications performed by the trained model AI in the verification data sets D3 as a numerator. In addition, the violation degree may be appropriately determined by a user of the trained model verification system.

The violation degree obtained by the violation degree calculating unit 130 is referred to as a violation degree D5. The violation degree D5 is sent to the verification result output unit 140.

Although the violation degree D5 is used as the evaluation index obtained by the violation degree calculating unit 130, the present disclosed technique is not limited thereto. The violation degree calculating unit 130 may select any one of an accuracy, a precision, a recall, a specificity, and an F-measure as the evaluation index.

The verification result output unit 140 is a component for outputting the evaluation index obtained by the violation degree calculating unit 130. The verification result output unit 140 may convert the evaluation index obtained by the violation degree calculating unit 130 into a format in which the evaluation index can be displayed as a diagram, a table, or a graph, and output a verification result D6.

FIG. 6 is a diagram illustrating evaluation indexes as a table. A “rule number” in the table illustrated in FIG. 6 may be considered as an index assigned to a category when the trained model AI solves a classification problem. A “rule” in the table illustrated in FIG. 6 may be considered to represent a region of a category obtained by the trained model AI by training, with a mathematical expression. A “violation degree rank” in the table illustrated in FIG. 6 may be considered to be obtained by ordering or ranking the violation degree D5. That is, FIG. 6 exemplifies that a correct answer ratio of classification by the trained model AI is the lowest for a rule number, that is, a category number of 3.

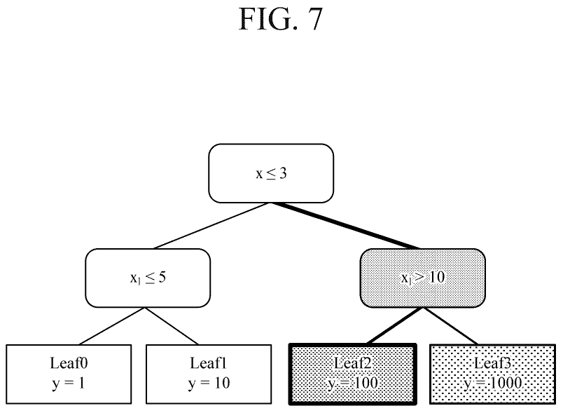

FIG. 7 is a diagram illustrating evaluation indexes according to the present disclosed technique in a form of a tree. The present disclosed technique converts the trained model AI into the rule model D2 of a decision tree, and therefore can easily display the evaluation indexes in a form of a tree. The present disclosed technique that displays evaluation indexes in a form of a tree in this manner has an affinity for a technician who is accustomed to handling the decision tree.

As illustrated in FIG. 7, the verification result output unit 140 may change the thickness of a path corresponding to a branch of the tree and change the color of a node corresponding to a leaf of the tree depending on a violation degree. In the example illustrated in FIG. 7, the leaf displayed as “Leaf2” has the worst evaluation index, a path displayed to be bold, and a node whose color is displayed to be dark.

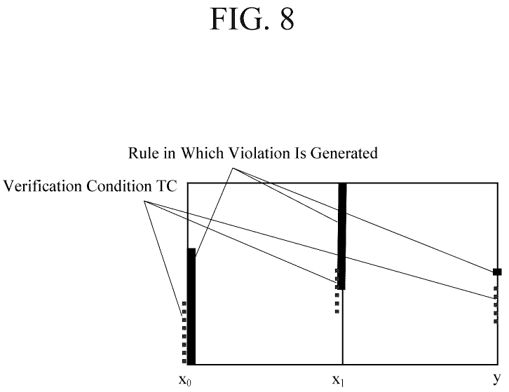

FIG. 8 is a diagram illustrating evaluation indexes according to the present disclosed technique in a form of a graph. In the example of FIG. 8, a horizontal axis represents a feature amount (x₀, x₁) and an output (y), and a range of each of the feature amount and the output is displayed as a vertical bar graph. In the vertical bar graph exemplified in FIG. 8, the verification condition TC is indicated by dots, and presence or absence of sample data exceeding the range of the verification condition TC can be seen at a glance.

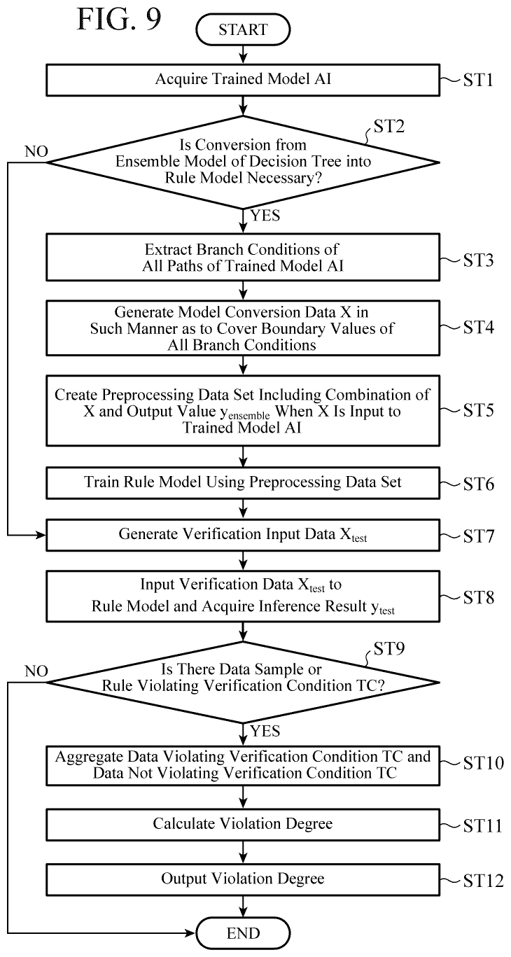

FIG. 9 is a flowchart illustrating processing steps of the trained model verification system according to the first embodiment. As illustrated in FIG. 9, the processing steps of the trained model verification system according to the first embodiment can be divided into steps ST1 to ST12.

Steps ST1 to ST6 are processing steps performed by the preprocessing device 300.

Steps ST7 to ST12 are processing steps performed by the verification device 100.

Step ST1 illustrated in FIG. 9 is a processing step performed by the preprocessing data set generating unit 310 of the preprocessing device 300. In step ST1, the preprocessing data set generating unit 310 acquires the trained model AI stored in the storage device 200.

Step ST2 illustrated in FIG. 9 is a processing step performed by the preprocessing data set generating unit 310 of the preprocessing device 300. In step ST2, the preprocessing data set generating unit 310 determines whether or not the trained model AI needs to be converted into a rule model. Here, if it is determined that the conversion into a rule model is necessary (YES), the processing step proceeds to step ST3. If it is determined that the conversion into a rule model is not necessary (NO), the processing step proceeds to step ST7.

It is possible to determine whether or not the trained model AI is a rule model by analyzing a source code of the trained model AI. The present disclosed technique stores the trained model AI in a form of a source code in the storage device 200.

Step ST3 illustrated in FIG. 9 is a processing step performed by the preprocessing data set generating unit 310 of the preprocessing device 300. In step ST3, the preprocessing data set generating unit 310 extracts branch conditions of all paths of the trained model AI.

Processing of extracting branch conditions of all paths for the trained model AI can be performed by analyzing a source code of the trained model AI.

Step ST4 illustrated in FIG. 9 is a processing step performed by the preprocessing data set generating unit 310 of the preprocessing device 300. In step ST4, the preprocessing data set generating unit 310 generates a set of input data (hereinafter, referred to as an “input data set (X)”) to the trained model AI in such a manner as to cover branch conditions of all paths, that is, boundary values of regions.

Step ST5 illustrated in FIG. 9 is a processing step performed by the preprocessing data set generating unit 310 of the preprocessing device 300. In step ST5, the preprocessing data set generating unit 310 generates the preprocessing data set D1 on the basis of the input data set (X) generated in step ST4. The preprocessing data set D1 includes the input data set (X) including an explanatory variable x and a set including an objective variable y_{ensemble} corresponding to each explanatory variable x.

Step ST6 illustrated in FIG. 9 is a processing step performed by the rule model converting unit 320 of the preprocessing device 300. In step ST6, the rule model converting unit 320 trains the rule model D2 in such a manner that the rule model D2 is equivalent to the trained model AI using the preprocessing data set D1 generated in step ST5. For example, even when the trained model AI is an ensemble model of a decision tree, the trained model AI can be converted into the rule model D2 represented by a rule model in step ST6.

Note that, instead of training the rule model D2 in such a manner that the rule model D2 is equivalent to the trained model AI using the preprocessing data set D1, it is also conceivable to additionally train the trained model AI using the preprocessing data set D1. Since the input data set (X) is generated in such a manner as to cover boundary values of regions in the preprocessing data set D1 according to the present disclosed technique, it can be expected that a correct answer ratio of the trained model AI is improved by this additional training.

In addition, after the trained model AI is additionally trained using the preprocessing data set D1, the processing from step ST1 to step ST6 may be repeatedly performed a plurality of times.

Step ST7 illustrated in FIG. 9 is a processing step performed by the verification data set generating unit 110 of the verification device 100. In step ST7, the verification data set generating unit 110 generates a set (Xₜₑₛₜ) including an explanatory variable x. Note that the set (Xₜₑₛₜ) including an explanatory variable x constitutes a part of the verification data set D3.

Step ST8 illustrated in FIG. 9 is a processing step performed by the verification unit 120 of the verification device 100. In step ST8, the verification unit 120 acquires an objective variable yₜₑₛₜ corresponding to each explanatory variable x generated in step ST7. The processing of acquiring the corresponding objective variable yₜₑₛₜ may be performed using the rule model D2.

Step ST9 illustrated in FIG. 9 is a processing step performed by the verification unit 120 of the verification device 100. In step ST9, the verification unit 120 verifies a training result of the trained model AI (rule model D2). As described above, in the verification performed by the verification unit 120, the verification condition TC in which a prediction range of a region of each category is expressed by a mathematical expression may be referred to.

As a result of referring to the verification condition TC, if there is a violation (YES), the processing step proceeds to step ST10. If there is no violation (NO), the processing step ends.

Step ST10 illustrated in FIG. 9 is a processing step performed by the violation degree calculating unit 130 of the verification device 100. In step ST10, the violation degree calculating unit 130 performs aggregation for calculating an evaluation index of the trained model AI (rule model D2).

Step ST11 illustrated in FIG. 9 is a processing step performed by the violation degree calculating unit 130 of the verification device 100. In step ST11, the violation degree calculating unit 130 calculates an evaluation index of the trained model AI (rule model D2) on the basis of the aggregation performed in step ST10.

Step ST12 illustrated in FIG. 9 is a processing step performed by the violation degree calculating unit 130 of the verification device 100. In step ST12, the violation degree calculating unit 130 converts the evaluation index calculated in step ST11 into a format in which the evaluation index can be displayed as a diagram, a table, or a graph, and output the converted evaluation index. Here, the format in which the evaluation index is displayed as a diagram includes a form of a tree (see FIG. 7).

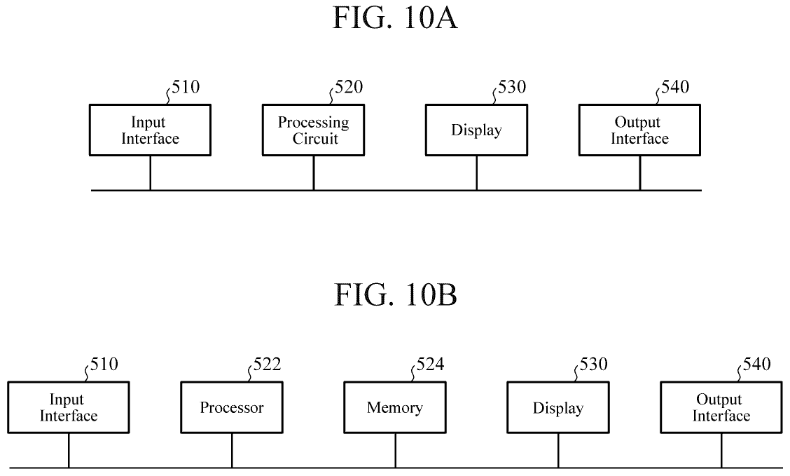

FIG. 10 is a diagram illustrating a hardware configuration of the trained model verification system 1000 according to the present disclosed technique. FIG. 10A is a diagram in a case where functions of the trained model verification system 1000 are executed by hardware. FIG. 10B is a diagram in a case where functions of the trained model verification system 1000 are executed by software.

As illustrated in FIG. 10, functions of the trained model verification system 1000 according to the present disclosed technique, particularly, functions of the preprocessing device 300 and the verification device 100 are implemented by a processing circuit. That is, the trained model verification system 1000 includes a processing circuit for performing the processing steps illustrated in FIG. 9. The processing circuit may be dedicated hardware or a central processing unit (CPU, also referred to as a central processing device, a processing device, an arithmetic device, a microprocessor, a microcomputer, a processor, or a DSP) that executes a program stored in a memory.

As illustrated in FIG. 10A, in a case where the processing circuit is dedicated hardware (hereinafter, the processing circuit is referred to as “processing circuit 520”), for example, a single circuit, a composite circuit, a programmed processor, a parallel programmed processor, an ASIC, a FPGA, or a combination thereof corresponds to the processing circuit 520. The functions of the preprocessing device 300 and the verification device 100 may be implemented by individual processing circuits 520, respectively, or may be collectively implemented by one processing circuit 520.

As illustrated in FIG. 10B, in a case where the processing circuit is a CPU (hereinafter, the CPU is referred to as “processor 522”), the functions of the preprocessing device 300 and the verification device 100 are implemented by software, firmware, or a combination of software and firmware. Software and firmware are each described as a program and stored in a memory 524. By reading and executing the program stored in the memory 524, the processing circuit implements the functions of the components. That is, the trained model verification system 1000 includes the memory 524 for storing a program that causes the processing steps illustrated in FIG. 9 to be executed as a result when the program is executed by the processing circuit. In addition, it can also be said that these programs cause a computer (corresponding to the whole of FIG. 10B) to execute procedures and methods performed by the preprocessing device 300 and the verification device 100. Here, the memory 524 may be a nonvolatile or volatile semiconductor memory such as a RAM, a ROM, a flash memory, an EPROM, or an EEPROM. In addition, the memory 524 may include a disk such as a magnetic disk, a flexible disk, an optical disk, a compact disk, a mini disk, or a DVD. Furthermore, the memory 524 may be in a form of an HDD or an SSD.

Note that some of the functions of the preprocessing device 300 and the verification device 100 may be implemented by dedicated hardware, and the remaining functions may be implemented by software or firmware.

In this way, the processing circuit can implement the functions of the trained model verification system 1000 by hardware, software, firmware, or a combination thereof.

As described above, the trained model verification system according to the present disclosed technique has the above configuration, and therefore enables verification of a mathematical model based on an algorithm other than an algorithm including a decision tree with a framework of the decision tree.

In addition, the trained model verification system according to the present disclosed technique can additionally train the trained model AI in such a manner as to cover boundary values of regions in the feature amount space, and has an effect of improving a correct answer ratio of the trained model AI.

### Second Embodiment

A content described in a second embodiment is a modification of the trained model verification system according to the first embodiment. In the second embodiment, the same reference signs as those used in the first embodiment are used unless otherwise specified. In the second embodiment, description overlapping with the first embodiment is appropriately omitted.

As described in the first embodiment, the present disclosed technique converts the trained model AI into the rule model D2 having the same input/output relationship as the trained model AI for the purpose of analyzing the trained model AI. Here, how strictly the rule model D2 approximating the trained model AI is created can be considered as a design matter.

For example, the trained model verification system according to the second embodiment may provide an upper limit value of the number of rules in the rule model D2 in processing of the rule model converting unit 320. The upper limit value of the number of rules in the rule model D2 can adjust how strictly the rule model D2 approximating the trained model AI is created as a design parameter.

The trained model verification system according to the second embodiment has the above configuration, and therefore can adjust how strictly the rule model D2 approximating the trained model AI is created in addition to the effect described in the first embodiment.

### Third Embodiment

A content described in a third embodiment is a modification of the trained model verification system according to the present disclosed technique. In the third embodiment, the same reference signs as those used in the above-described embodiments are used unless otherwise specified. In the third embodiment, description overlapping with the above-described embodiments is appropriately omitted.

In the first embodiment, as the evaluation index calculated by the violation degree calculating unit 130, an accuracy, a precision, a recall, a specificity, and an F-measure are used assuming that a problem solved by the trained model AI is a classification problem. In addition, as the evaluation index calculated by the violation degree calculating unit 130, a violation degree may be used.

In a case where the problem solved by the trained model AI is a regression problem, the evaluation index calculated by the violation degree calculating unit 130 may be an evaluation index suitable for the regression problem. As the evaluation index in the regression problem, a root mean squared error (RMSE), a root mean squared logarithmic error (RMSLE), a mean absolute error (MAE), a determination coefficient, and the like are conceivable.

In addition, as the evaluation index calculated by the violation degree calculating unit 130, an evaluation index appropriately determined by a user of the trained model verification system (for example, a “deviation degree” is defined and used) may be used.

The trained model verification system according to the third embodiment has the above configuration, and therefore exhibits the effects described in the above-described embodiments even when the problem solved by the trained model AI is a regression problem.

Note that the trained model verification system according to the present disclosed technique is not limited to the aspects exemplified in the embodiments, and it is possible to combine the embodiments, to modify any component of each of the embodiments, or to omit any component in each of the embodiments.

### INDUSTRIAL APPLICABILITY

The present disclosed technique can be used for verification and additional training of artificial intelligence that performs classification, regression, or recognition, and thus has industrial applicability.

### REFERENCE SIGNS LIST

100: verification device, 110: verification data set generating unit (verification data set generator), 120: verification unit (verificator), 130: violation degree calculating unit (violation degree calculator), 140: verification result output unit (verification result output interface), 200: storage device, 300: preprocessing device, 310: preprocessing data set generating unit (preprocessing data set generator), 320: rule model converting unit (rule model convertor), 400: output device, 510: input interface, 520: processing circuit, 522: processor, 524: memory, 530: display, 540: output interface, 1000: trained model verification system

What is claimed is:

1. A trained model verification system comprising:
a rule model convertor to convert a trained model to be verified into a rule model having an input/output relationship equivalent to that of the trained model;
a verification data set generator to generate a verification data set for the rule model; and
a verificator to verify the rule model or the trained model using the verification data set.

2. The trained model verification system according to claim 1, further comprising:
a violation degree calculator to calculate an evaluation index of the rule model or the trained model using the verification data set; and
a verification result output interface to convert the evaluation index into a format in which the evaluation index can be displayed as a diagram, a table, or a graph and to output the converted evaluation index.

3. The trained model verification system according to claim 2, wherein
the format includes a form of a tree.

4. The trained model verification system according to claim 1, wherein
the rule model convertor can set an upper limit value of the number of rules as a design parameter.
